(19) United States
(12) Patent Application Publication
(10) Pub. No.: US 2017/0307267 A1
(43) Pub. Date: Oct. 26, 2017

(54) ELECTROMAGNETICALLY ACTUATABLE EXPANSION VALVE

(71) Applicant: Robert Bosch GmbH, Stuttgart (DE)

(72) Inventor: Tobias Landenberger, Schorndorf (DE)

(21) Appl. No.: 15/507,377

(22) PCT Filed: Aug. 18, 2015
(86) PCT No.: PCT/EP2015/068934

§ 371 Date: Feb. 28, 2017

(30) Foreign Application Priority Data
Sep. 1, 2014 (DE) 10 2014 217 375.2

(51) Int. Cl. F25B 41/06; F16K 31/06

(52) U.S. Cl. CPC F25B 41/062; F16K 31/0668; F25B 2341/065

(57) ABSTRACT

The invention relates to an electromagnetically actuatable expansion valve for a refrigerant, said valve comprising a valve body (1) with a bore (2), in which a substantially cylindrical valve slide (3) is arranged such that it can be displaced axially in order to connect a supply line (4) to a discharge line (5). According to the invention, the discharge line (5) is formed by a hollow cylinder (6) which is inserted in the bore (2) and the end of which facing the valve slide (3) forms a valve seat (7) that can be closed by means of a separate valve closure element (8).

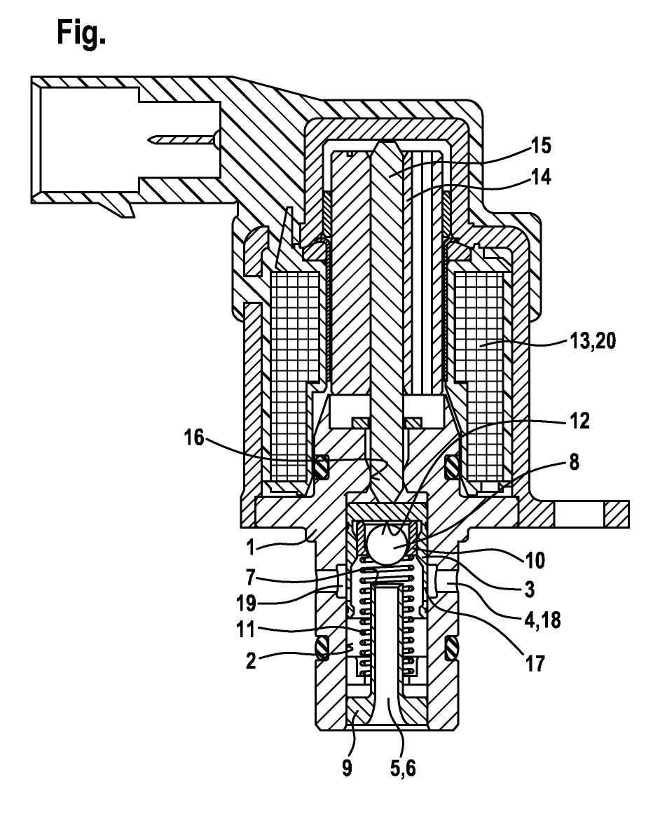

### BRIEF DESCRIPTION OF THE INVENTION

The invention relates to an electromagnetically actuatable expansion valve for a refrigerant. The expansion valve is used preferably in an air-conditioning circuit, wherein it is arranged, in particular, downstream of a condenser and upstream of an evaporator. The task of such an expansion valve is to provide for controlled expansion of a refrigerant, which is initially compressed, and is then expanded again for cooling purposes, in the air-conditioning circuit. Known air-conditioning circuits make use, for example, of partially halogenated hydrofluorocarbons (HFCs) as their refrigerant. However, it is also possible to use carbon dioxide (CO₂) as a refrigerant.

Laid-open application DE 103 54 229 A1 discloses an expansion valve for a refrigerant which comprises a valve housing with a valve chamber, in which a throttle body is accommodated in an axially adjustable manner. The axial adjustment of the throttle body can throttle or block the throughflow through the expansion valve between an inflow and an outflow. The axial adjustment is achieved via an actuator, which can be adjusted counter to the force of a valve spring in dependence on operating parameters and environmental parameters. The throttle body proposed is a hollow-cylindrical valve slide which, on its circumference, has at least one control bore which interacts with at least one inflow bore in the valve housing. Also provided is a valve plate, which is connected to the valve slide via a valve stem and is directed toward a valve seat, which encloses an outflow opening in the valve housing. The axial position of the control bore of the valve slide is defined here such that the inlet bore is closed even before the valve plate is positioned on the valve seat.

Accordingly, the expansion valve of DE 103 05 947 A1 constitutes a combination of a slide valve and seat valve, only an actuator being required in order to actuate the valve slide and the valve plate. The slide valve allows precise regulation of the throughflow, whereas the seat valve, on account of its high level of sealing, has a shut-off function, which is desirable for example for safety reasons. A shut-off function cannot usually be realized via a slide valve alone, since the guidance of the valve slide in the valve housing is prone to leakage.

In the case of the known expansion valve, the valve plate belonging to the seat valve is arranged in the flow path of the refrigerant between the inflow and outflow. This means that refrigerant flows around the valve plate during normal operation.

### SUMMARY OF THE INVENTION

Proceeding from the aforementioned prior art, it is the object of the present invention to specify an electromagnetically actuatable expansion valve which is optimized in terms of flow. The intention is also to specify an expansion valve which is straightforward and cost-effective to produce.

The electromagnetically actuatable expansion valve of the invention is proposed in order to achieve the object.

The electromagnetically actuatable expansion valve proposed comprises a valve body with a bore, in which an essentially sleeve-like valve slide is accommodated in an axially displaceable manner in order to connect an inlet to an outlet. According to the invention, the outlet is formed by a hollow cylinder, which is inserted into the bore of the valve body and, at its end which is directed toward the valve slide, forms a valve seat, which can be closed via a separate valve-closing element. The valve seat is shifted inward by the hollow cylinder, which is inserted into the valve body and has a certain axial extent. Accordingly, the valve-closing element, which interacts with the valve seat can be arranged such that, when the seat valve is open, it ends up located outside the flow path of the refrigerant. This means that the refrigerant does not flow around the valve-closing element during normal operation of the expansion valve and, accordingly, the valve-closing element does not obstruct the refrigerant outflow.

The hollow cylinder, which is inserted into the valve body, preferably has a collar region, which extends radially outward and allows a force-fitting, form-fitting and/or integral connection between the hollow cylinder and the valve body. For example, the hollow cylinder can be pressed or screwed into the valve body via the collar region. As an alternative, or in addition, the hollow cylinder can be adhesively bonded or welded to the valve body in the collar region. Accordingly, the collar region of the hollow cylinder simultaneously seals in the outward direction the bore of the valve body, said bore serving as the valve chamber. The bore of the valve body can be designed in the form of a straightforward cylindrical bore, which allows straightforward installation of the expansion valve.

Further preferably, the valve-closing element, which interacts with the valve seat, can be displaced axially via the valve slide. Accordingly, there is no need for any adjusting means beyond those which are necessary in any case for the axial displacement of the valve slide.

It is also proposed that the valve-closing element should be accommodated in the valve slide. Since the valve slide is of essentially sleeve-like design, the cavity enclosed by the valve slide can be used in order to accommodate the valve-closing element. This achieves not just a compact arrangement, but preferably also an arrangement in which the valve-closing element ends up located outside the flow path of the refrigerant when the seat valve is open. This is because it is preferably the case that the valve-closing element is arranged within the essentially sleeve-like valve slide on the far side of a control opening or control edge formed in or on the valve slide.

The valve-closing element is advantageously of spherical design. A spherical valve-closing element interacts in a self-centering manner with the valve seat, and this ensures a high level of sealing for the seat valve. The valve seat is preferably conical, and this can be achieved by the hollow cylinder, which is inserted into the valve body, being provided with a chamfer on its inner circumference.

A development of the invention proposes that the spherical valve-closing element should be surrounded by a cage, which is forced by the force of a spring in the direction of a base surface of the valve slide. The cage ensures that the seat valve remains open as long as the expansion valve is operating as it should.

The force of the spring, which forces the cage in the direction of the base surface of the valve slide, preferably opposes the magnetic force of an electromagnet, which serves for actuating the expansion valve. This is advantageous, in particular, when the expansion valve is a normally open valve. This is because the spring can then, at the same time, perform the function of a valve spring of which the force keeps the valve open.

The electromagnet proposed in order to actuate the expansion valve interacts preferably with a displaceable armature and an armature bolt, which is connected to the armature. By virtue of the electromagnet being energized, the displacement of the armature, and thus of the armature bolt, can be influenced such that the refrigerant throughflow can be controlled thereby. This is because, advantageously, the displacement of the armature is transmitted directly to the valve slide via the armature bolt.

As a further-reaching measure, it is therefore proposed, for mechanical coupling to the valve slide, the armature bolt should be guided through a central opening of the valve body. The armature bolt preferably butts directly against a base of the essentially sleeve-like valve slide.

The essentially sleeve-like valve slide preferably has at least one lateral-surface through-passage which, in order to connect the inflow to the outflow, can be made to coincide with an annular groove and/or radial bore formed in the valve body. Accordingly, the at least one lateral-surface through-passage serves as a control opening, it being possible for the refrigerant through-flow to be controlled via the freed cross section of said control opening. The annular groove and/or radial bore provided in the valve body, and serving as an inlet, defines a control edge, which interacts with the control opening.

According to a preferred embodiment of the invention, the expansion valve is normally open. This means that the force of a spring keeps the valve open in its de-energized state. This may be, in particular, the spring which—if provided—at the same axially prestresses the cage in the direction of the base surface of the valve slide.

Further preferably, the outlet can only be closed via the valve-closing element when, at the same time, the connection between the inlet and the outlet has been interrupted by the valve slide. This ensures that the function of the slide valve is maintained over the entire regulating region.

### BRIEF DESCRIPTION OF THE DRAWING

A preferred embodiment of the invention will be explained in more detail hereinbelow with reference to the accompanying drawing.

The FIGURE shows a schematic longitudinal section through a preferred embodiment of an expansion valve according to the invention.

### DETAILED DESCRIPTION OF THE DRAWING

The expansion valve illustrated schematically in the FIGURE comprises a valve body 1 with a bore 2, in which a valve slide 3 is accommodated in an axially displaceable manner. The valve slide 3 is of essentially sleeve-like design and has lateral-surface through-passages 17, which can be made to coincide with an annular groove 19, into which open out radial bores 18 which serve as an inlet 4. Accordingly, in dependence on the axial position of the through-passages 17 of the valve slide 3 in relation to the annular groove 19 of the valve body 1, it is possible to free a flow cross section which determines the throughflow and can be altered via axial displacement of the valve slide 3.

In order also to realize a shut-off function, the expansion valve additionally has a spherical valve-closing element 8, which interacts with a valve seat 7. The expansion valve illustrated is thus designed in the form of a slide/seat valve. This means that it combines the functions of a slide valve and a seat valve. The valve seat 7 is formed on a hollow cylinder 6, which is inserted into the valve body 1 and is connected to the latter in a force-fitting manner via a collar region 9. The hollow cylinder 6 serves, at the same time, as an outlet 5. On account of the distance by which the hollow cylinder extends axially into the valve body 1, the valve seat 7 ends up located approximately centrally in relation to the axial extent of the bore 2. In the present case, the valve seat 7 is located level with the center axis of the radial bores 18 serving as the inlet 4. The spherical valve-closing element 8 is kept in abutment against the valve slide 3 by a cage 10. For this purpose, the cage 10 is prestressed axially in relation to a base surface 12 of the valve slide 3 by means of the force of a spring 11. The spring 11 serves, at the same time, as a valve spring, of which the force keeps the expansion valve open in its de-energized state.

By virtue of the valve-closing element 8 being arranged within the valve slide 3, said valve-closing element ends up located outside the flow path of the coolant. This optimizes flow through the expansion valve.

It is also the case that both the advantages of a slide valve and the advantages of a seat valve, these advantages consisting, in particular, in that the slide valve allows precise regulation of the throughflow and the seat valve allows complete shut-off, come to the fore.

The slide/seat valve design, however, requires just one actuating means. In the present case, this is formed by an electromagnet 13. The electromagnet 13 comprises an annular coil 20, which surrounds certain regions of a displaceable armature 14. The armature 14 is connected to an armature bolt 15, which serves to transmit the displacement of the armature 14 to the valve slide 3. For this purpose, the armature bolt 15 is guided through an opening 16 of the valve body 1, and therefore it butts against the end side of the valve slide 3. If the coil 20 of the electromagnet 13 is energized, this results in the formation of a magnetic field, of which the magnetic force pulls the armature 14 downward. The armature 14 here carries along the armature bolt 15, which, in turn, causes the valve slide 3 to be adjusted axially. The region over which the lateral-surface through-passages 17 of the valve slide 3 coincide with the annular groove 19 of the valve body 1 alters here, and therefore the throughflow is reduced. If the annular groove 19 is covered over completely, the connection between the inlet 4 and the outlet 5 is interrupted by the valve slide 3. However, the valve slide 3 does not fully seal the annular gap remaining between it and the valve body 1, and therefore refrigerant can continue to penetrate into the valve by way of leakage. In this phase, then, use is made of the seat valve, since, as advancement of the valve slide 3 continues, the latter pushes the spherical valve-closing element 8 into the valve seat 7. The high level of sealing of the seat valve ensures that the refrigerant no longer passes outward via the outlet 5.

1. An electromagnetically actuatable expansion valve for a refrigerant, the expansion valve comprising a valve body (1) with a bore (2), in which an essentially sleeve-like valve slide (3) is accommodated in an axially displaceable manner in order to connect an inlet (4) to an outlet (5), wherein the outlet (5) is formed by a hollow cylinder (6) which is inserted into the bore (2), wherein an end of the hollow cylinder, which is directed toward the valve slide (3), forms a valve seat (7), and wherein the expansion valve also comprises a separate valve-closing element (8) movable to engage the valve seat (7) to close the outlet (5).

2. The expansion valve as claimed in claim 1,
characterized in that the hollow cylinder (6) has a collar region (9), which extends radially outward and allows a force-fitting, form-fitting and/or integral connection between the hollow cylinder (6) and the valve body (1).

3. The expansion valve as claimed in claim 1, characterized in that the valve-closing element (8) is configured to be displaced axially via the valve slide (3).

4. The expansion valve as claimed in claim 1,
characterized in that the valve-closing element (8) is accommodated in the valve slide (3).

5. The expansion valve as claimed in claim 1,
characterized in that the valve-closing element (8) is spherical, wherein the spherical valve closing element (8) is surrounded by a cage (10), which is forced by a force of a spring (11) in a direction of a base surface (12) of the valve slide (3).

6. The expansion valve as claimed in claim 5,
characterized in that the force of the spring (11) opposes a magnetic force of an electromagnet (13), which serves for actuating the expansion valve, wherein the electromagnet (13) interacts with a displaceable armature (14) and an armature bolt (15), which is connected to the armature (14).

7. The expansion valve as claimed in claim 6,
characterized in that, for mechanical coupling to the slide valve (3), the armature bolt (15) is guided through a central opening (16) of the valve body (1).

8. The expansion valve as claimed in claim 1,
characterized in that the essentially sleeve-like valve slide (3) has at least one lateral-surface through-passage (17) which, in order to connect the inlet (4) to the outlet (5), is configured to coincide with an annular groove (19) and/or radial bore (18) formed in the valve body (1).

9. The expansion valve as claimed in claim 1,
characterized in that the expansion valve is normally open.

10. The expansion valve as claimed in claim 1,
characterized in that the outlet (5) can only be closed via the valve-closing element (8) when, at the same time, the connection between the inlet (4) and the outlet (5) has been interrupted by the valve slide (3).

11. The expansion valve as claimed in claim 1,
characterized in that the valve-closing element (8) is spherical.

12. The expansion valve as claimed in claim 5,
characterized in that the force of the spring (11) opposes a magnetic force of an electromagnet (13), which serves for actuating the expansion valve.

13. The expansion valve as claimed in claim 5,
characterized in that the expansion valve is normally open, wherein the force of the spring (11) keeps the expansion valve open.
